(19) United States
(12) Patent Application Publication
(10) Pub. No.: US 2018/0328374 A1
(43) Pub. Date: Nov. 15, 2018

(54) TURBOFAN ENGINE

(71) Applicant: Rolls-Royce Deutschland Ltd & Co KG, Blankenfelde-Mahlow (DE)

(72) Inventor: Bjorn PETERSEN, Berlin (DE)

(21) Appl. No.: 15/961,113

(22) Filed: Apr. 24, 2018

(30) Foreign Application Priority Data
May 9, 2017 (DE) 10 2017 109 940.9

(51) Int. Cl. F04D 29/053; F02K 3/06

(52) U.S. Cl. CPC F04D 29/053; F05D 2260/30; F05D 2220/323; F02K 3/06

(57) ABSTRACT

A turbofan engine has a fan with a fan disc, a low-pressure shaft connected to the fan disc, and a non-rotating structural component arranged downstream of the fan disc. A downstream section of the fan disc has first locking sections arranged at a distance from each other in the circumferential direction, and an upstream section of the structural component has second locking sections arranged at a distance from each other in the circumferential direction. The first and the second locking sections are configured and arranged with respect to each other such that they are out of mesh with each other in normal operation, wherein the first locking sections have a more downstream axial position than the second locking sections. In the event of a break of the low-pressure shaft or of the fan disc, the first locking sections come to rest against the second locking sections.

This application claims priority to German Patent Application DE102017109940.9 filed May 9, 2017, the entirety of which is incorporated by reference herein.

### DESCRIPTION

The invention relates to a turbofan engine according to the generic term of patent claim 1.

It is known to drive the fan of a turbofan engine by means of a low-pressure shaft arranged on the axis of the turbofan engine, with the low-pressure shaft coupling the fan to a low-pressure turbine of the turbofan engine. This drive can be realized in a direct manner or with a transmission gearing placed in between. In the event of the low-pressure shaft breaking, measures for securing the turbofan engine against any axial detachment of the fan from the engine are necessary.

What is known for this purpose, for example from U.S. Pat. No. 8,721,260 B2, is to axially secure the fan by means of a second fan shaft that provides a connection of the low-pressure fan shaft to an axially rear point of the low-pressure shaft. However, due to the necessity for an additional shaft and for its attachment at the fan shaft, such a solution is elaborate and weight-intensive. Moreover, it only works if the low-pressure shaft breaks, but not if the break occurs at the fan disc.

The present invention is based on the objective of providing a securing of the fan against an axial detachment of the fan in the event of a shaft break, which prevents a detachment of the fan from the engine also in the event that the fan disc breaks.

According to the invention, the objective is achieved through a turbofan engine with the features of claim 1. Embodiments of the invention are specified in the subclaims.

In this invention a downstream section of the fan disc has a plurality of first locking sections that are arranged at a distance from each other in the circumferential direction. Further, an upstream section of a non-rotating structural component arranged downstream of the fan disc has a plurality of second locking sections that are also arranged at a distance from each other in the circumferential direction. Here, it is provided that the first and the second locking sections are configured and arranged with respect to each other in such a manner that the first and the second locking sections are out of mesh in normal operation, wherein the first locking sections have a more downstream axial position than the second locking sections. Further, the first and the second locking sections are embodied and arranged with respect to each other in such a manner that in the event of a break of the low-pressure shaft or of the fan disc, when the fan disc is displaced upstream in the axial direction, the first locking sections come into contact with the second locking sections and come to rest against the same, whereby an axial displacement of the fan disc or of the fan is prevented in total.

The invention thus provides a securing of the fan in which an additional mechanical connection of the fan disc to the axially rear point of the low-pressure shaft can be foregone. In addition, the invention facilitates a securing of the fan also in the case that the fan disc breaks. Here, in the event of the break of the low-pressure shaft or the fan disc, the invention is based on the idea to provide a securing of the fan by a meshing of elements of the fan disc with elements of the non-rotating structural component that is arranged downstream of the fan or of the fan disc.

The downstream section of the fan disc comprising the plurality of first locking sections can be an integral component of the fan disc, or alternatively can be a structure that is connected to the fan disc, thus forming a downstream extension of the fan disc.

It is to be understood that the present invention is described with respect to a cylindrical coordinate system, having the coordinates x, r and φ. Here, x indicates the axial direction, r indicates the radial direction, and φ indicates the angle in the circumferential direction, with the axial direction being identical to the machine axis of the turbofan engine in which the invention is realized. Beginning at the x-axis, the radial direction points radially outward. Terms such as “in front”, “behind”, “frontal” and “rear” always refer to the axial direction or the flow direction inside the engine. Thus, the term “in front” means “upstream”, and the term “behind” means “downstream”. Terms such as “outer” or “inner” always refer to the radial direction.

In one embodiment of the invention the first locking sections and the second locking sections are respectively oriented obliquely to a plane that extends perpendicular to the machine axis of the turbofan engine. Thus, the locking sections do not extend exactly in the circumferential direction, but at an acute angle to the circumferential direction. Through the inclined position of the locking sections it is achieved that during mounting the first locking sections can be brought into a more downstream axial position than the second locking sections, without the distance between the second locking sections in the circumferential direction being greater than the length of the first locking sections in the circumferential direction (in which case a securing against axial displacement would not be possible, since in this case the first locking sections of the fan disc are guided past the second locking sections in the axial direction, without the the first and the second locking sections coming into mesh). Due to the inclined position, the first locking sections can be guided obliquely past the second locking sections and axially behind them during mounting.

Here, it is provided that the first locking sections of the fan disc and the second locking sections of the non-rotating structural component extend substantially by the same angle (i.e. the identical angle or similar angles, e.g. with a deviation of less or equal 2°) obliquely to the plane that extends perpendicular to the machine axis. In this manner, it is achieved that, in the event of a break, they come into abutment with each other over a large part of their surface or their entire surface, and the fan disc is reliably retained. The mentioned angle may for example lie between 5° and 45°, in particular between 10° and 30°.

In a further embodiment of the invention it is provided that the first locking sections and the second locking sections are respectively embodied as first and a second wall sections that respectively extend obliquely to the circumferential direction and in the radial direction. At that, the wall sections represent wall-like plates extending in the radial direction. They are aligned at an acute angle to the circumferential direction. At that, the first wall sections are aligned in parallel with respect to each other, and the second wall sections are also aligned in parallel to each other. At the same time, the first wall sections are aligned in parallel to the second wall sections in the mounted state.

Since the first and second locking sections are embodied respectively at a ring-shaped three-dimensional object, the term “in parallel” is to be understood such that a parallelism is present in the theoretically cut-open ring rolled out in a plane (unrolled radial section).

In one embodiment of the invention it is provided that the first locking sections are formed at a first web that protrudes from the fan disc in the axial direction in downstream direction. At that, the first locking sections extend radially outwards beginning at the first web.

Further, the second locking sections extend radially inwards from a flow-path-delimiting structure of the non-rotating structural component.

However, the radial orientations of the first and second locking sections can also be reversed. Thus, it is provided in an alternative embodiment of the invention that the first locking sections are formed at a first web that protrudes from the fan disc in the axial direction in downstream direction. Here, the first locking sections extend radially inwards beginning at the first web. Accordingly, it can further be provided that the second locking sections extend radially outwards from a structure of the non-rotating structural component.

In a further embodiment it is provided that the fan disc forms a second web that projects downstream in the axial direction and that is arranged at the radial exterior (i.e. radially outside) of the second locking sections, axially adjoining the flow-path-delimiting structure of the non-rotating structural component. This has two advantages. For one thing, in the axial area inside of which it extends, the second web forms the hub-side boundary of the flow path through the fan, so that swirling in the area of the first and second locking sections are prevented. For another thing, through the formation of the second web radially outside of the second locking sections, it is avoided that the second locking sections can break out radially in the event of a shaft or fan disc breaking.

Since the first and the second locking sections are arranged at the fan disc or at a structural component that is arranged behind the fan disc and delimits the flow channel behind the fan radially inside, they respectively extend in a ring-shaped manner.

In one embodiment of the invention, it is provided that the first locking sections and the second locking sections are respectively oriented and arranged at a distance in the circumferential direction in such a manner that for mounting the first locking sections can be displaced in the transverse direction in between the second locking sections, so that in normal operation the first locking sections have a more downstream axial position than the second locking sections. This type of mounting is facilitated by the inclined position of the first and second locking sections. Here, it is to be understood that the first locking sections are passed through in between the second locking sections with a movement direction having a component in the circumferential direction that is equal to the rotational direction of the fan during operation. For decoupling the locking sections, it would therefore be necessary to rotate the fan disc against the rotational direction. Since this is obviously not the case following a break of the shaft or the fan disc, it is excluded that the first locking sections and the second locking sections are separated from each other following a break situation, without the respective locking sections coming into mesh with each other.

In one embodiment of the invention, it is provided that the first locking sections and the second locking sections are respectively arranged at a distance from each other in the circumferential direction in such a manner that a first locking section and a second locking section arranged at an axial distance thereto overlap at least partially at all times in the circumferential direction as viewed upstream in the axial direction. Thanks to this overlap, it is specifically avoided that the first locking sections and the second locking sections can disengage again through an axial displacement of the fan or the fan disc.

According to one embodiment, the invention provides that the first locking sections are arranged respectively equidistantly with respect to each other in the circumferential direction. The same applies to the second locking sections. It can also be provided that the first locking sections all have the same length in the circumferential direction, and that the second locking sections all have the same length in the circumferential direction.

Further, it is to be understood that the length of the first locking sections in the circumferential direction can be different than the length of the second locking sections in the circumferential direction. In particular in one embodiment of the invention it is provided that the length of the first locking sections in the circumferential direction is smaller than the length of the second locking sections in the circumferential direction, so that the rotating structural component supporting the first locking sections (i.e. the fan disc) can be minimized with respect to its weight. However, in principle it can also be provided that the length of the first locking sections in the circumferential direction is greater than the length of the second locking sections in the circumferential direction, or that these lengths are equal.

According to one embodiment of the invention, the first locking sections are formed at the axial rear end face of the fan disc. The second locking sections are formed at the axially frontal end face of the non-rotating structural component arranged downstream of the fan disc. Further, according to one embodiment of the invention, the downstream section of the fan disc comprising the first locking sections and the upstream section of the non-rotating structural component comprising the second locking sections form an interface between the fan disc and the non-rotating structural component, which is formed in a position close to the hub, i.e. in a radial area adjoining the fan hub or a flow-path-delimiting structure of the non-rotating structural component.

In a further embodiment of the invention it is provided that the first locking sections are embodied integrally with the fan disc. In principle, they can also be elements that are connected to the fan disc, for example by means of bolts or screws.

In the following, the invention is explained in more detail based on multiple exemplary embodiments by referring to the Figures of the drawing. Herein:

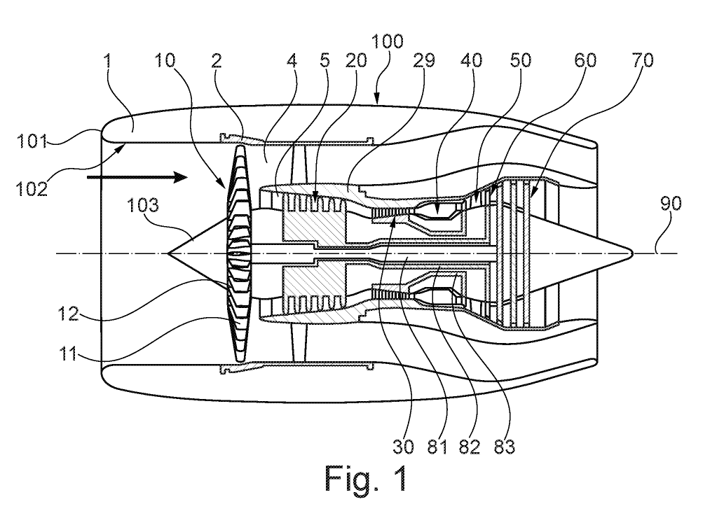

FIG. 1 shows a simplified schematic sectional view of a turbofan engine in which the present invention can be realized;

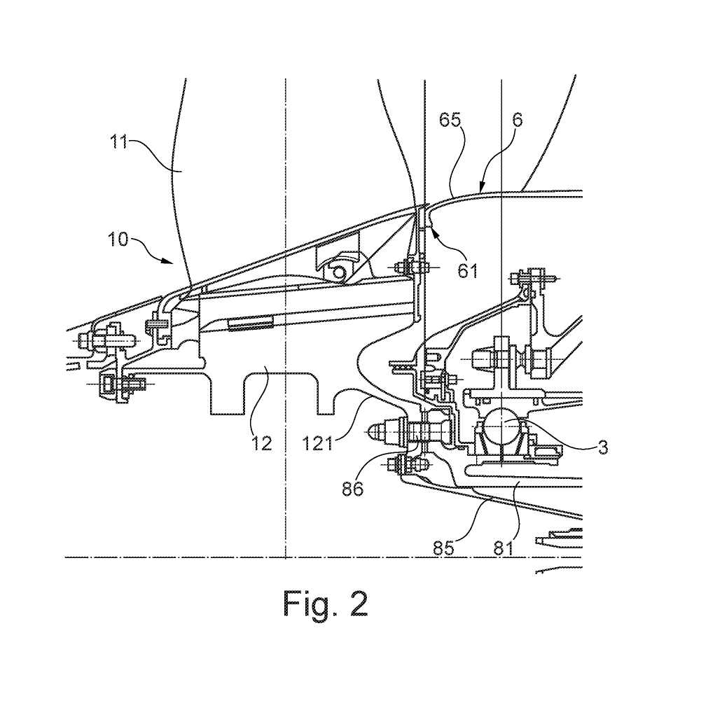

FIG. 2 shows an exemplary embodiment of a fan securing device according to the state of the art;

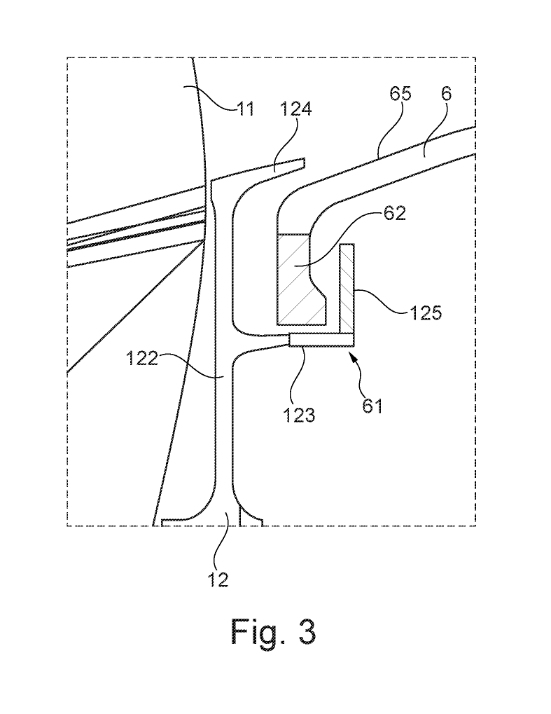

FIG. 3 shows, in longitudinal section, an exemplary embodiment of a fan securing device with first locking sections and second locking sections, wherein the normal operation is shown, in which the first locking sections and the second locking sections are out of mesh with each other;

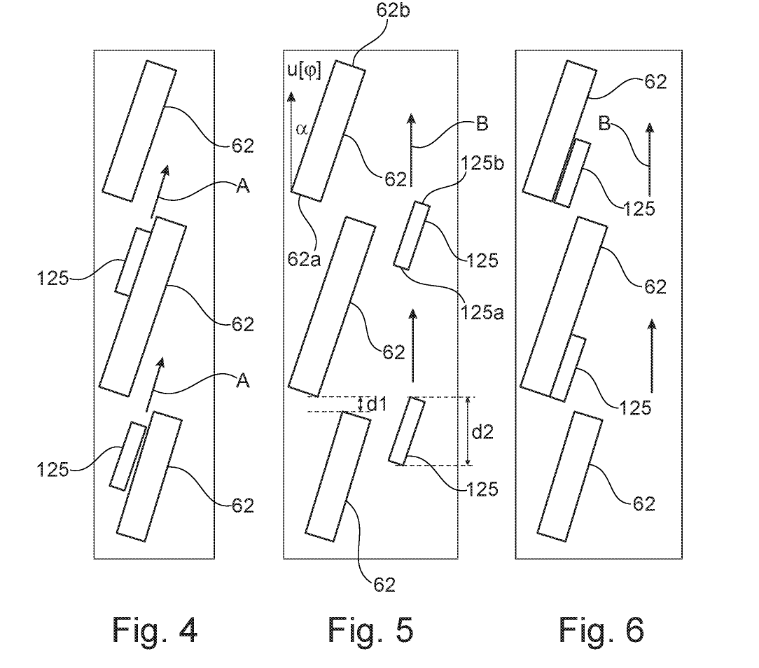

FIG. 4 shows, schematically and in unrolled radial section, the exemplary embodiment of FIG. 3 during mounting of the fan securing device, wherein the first and second locking sections are shown in a flatly spread-out manner;

FIG. 5 shows, schematically and in unrolled radial section, the exemplary embodiment if FIG. 3 in normal operation, wherein the first and second locking sections are shown in a flatly spread-out manner;

FIG. 6 shows, schematically and in unrolled radial section, the exemplary embodiment of FIG. 3 after a shaft break, wherein the first and second locking sections are shown in a flatly spread-out manner;

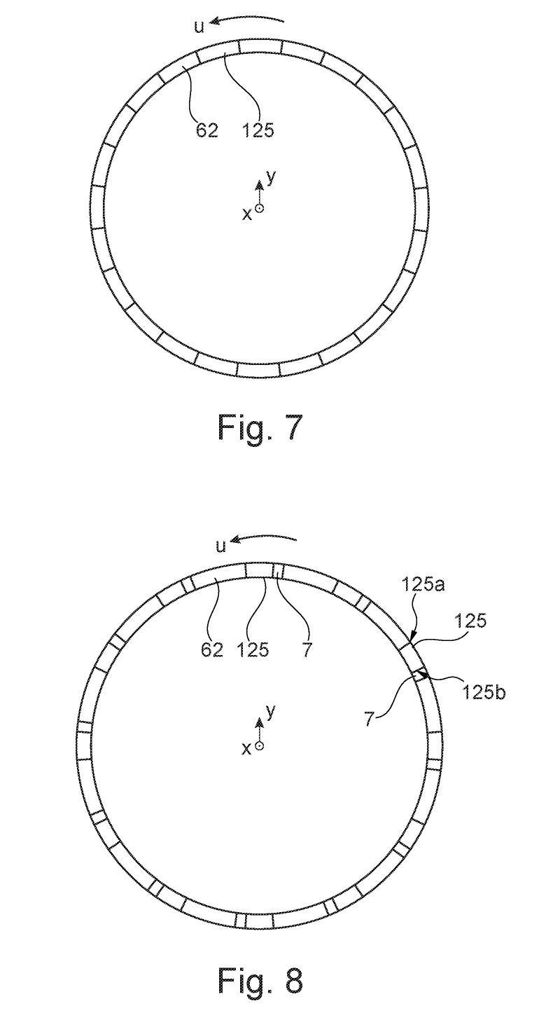

FIG. 7 shows the exemplary embodiment of FIG. 3, as viewed upstream in the axial direction, in an operational state of the system in which the first locking sections and the second locking sections overlap each other completely in the circumferential direction; and

FIG. 8 shows a modified exemplary embodiment, as viewed upstream in the axial direction, in an operational state of the system in which the first locking sections and the second locking sections overlap each other partially in the circumferential direction.

FIG. 1 shows a turbofan engine 100 in a schematic manner, that has a fan stage with a fan 10 as the low-pressure compressor, a medium-pressure compressor 20, a high-pressure compressor 30, a combustion chamber 40, a high-pressure turbine 50, a medium-pressure turbine 60, and a low-pressure turbine 70. At that, the turbofan engine can have a geared fan, wherein the fan is connected via a gear to the low-pressure shaft.

The medium-pressure compressor 20 and the high-pressure compressor 30 respectively have a plurality of compressor stages that respectively comprise a rotor stage and a stator stage. The turbofan engine 100 of FIG. 1 further has three separate shafts, a low-pressure shaft 81 that connects the low-pressure turbine 70 to the fan 10, a medium-pressure shaft 82 that connects the medium-pressure turbine 60 to the medium-pressure compressor 20, and a high-pressure shaft 83 that connects the high-pressure turbine 50 to the high-pressure compressor 30. However, this is to be understood merely as an example. If, for example, the turbofan engine has no medium-pressure compressor and no medium-pressure turbine, only a low-pressure shaft and a high-pressure shaft would be present.

The turbofan engine 100 has an engine nacelle 1 that comprises an inlet lip 101 and forms an engine inlet 102 at the inner side, supplying inflowing air to the fan 10. The fan 10 has a plurality of fan blades 11 that are connected to a fan disk 12. Here, the annulus of the fan disk 12 forms the radially inner boundary of the flow path through the fan 10. Radially outside, the flow path is delimited by the fan housing 2. Upstream of the fan-disc 12, a nose cone 103 is arranged.

Behind the fan 10, the turbofan engine 100 forms a secondary flow channel 4 and a primary flow channel 5. The primary flow channel 5 leads through the core engine (gas turbine) which comprises the medium-pressure compressor 20, the high-pressure compressor 30, the combustion chamber 40, the high-pressure turbine 50, the medium-pressure turbine 60, and the low-pressure turbine 70. At that, the medium-pressure compressor 20 and the high-pressure compressor 30 are surrounded by a circumferential housing 29 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or elements of the corresponding drive shaft connected to the hub.

During operation of the turbofan engine 100, a primary flow flows through the primary flow channel 5, which is also referred to as the main flow channel. The secondary flow channel 4, which is also referred to as the partial-flow channel or bypass channel, guides air sucked in by the fan 10 during operation of the turbofan engine 100 past the core engine.

The described components have a common rotational or machine axis 90. The rotational axis 90 defines an axial direction of the turbofan engine. A radial direction of the turbofan engine extends perpendicularly to the axial direction.

What is important in the context of the present invention is a fan securing device 10 against an upstream-directed axial detachment in the event of a break of the low-pressure shaft 81 or of the fan disc 12.

To provide a better understanding of the background of the present invention, FIG. 2 shows a fan securing device according to the state of the art of the engine BR710. What is shown is a front part of the turbofan engine. A fan 10 has a fan disc 12 that is coupled via attachment elements 86 to a low-pressure shaft 81. A front bearing 3 for mounting the low-pressure shaft 81 is shown. At its radially outer edge, the fan disc 12 forms a fan hub that delimits the flow channel through the fan 10 radially inside. A plurality of fan blades 11 extend radially outwards from the fan hub into the flow channel. The fan blades 11 can be formed in one piece with the fan disc 12 or, as in the shown exemplary embodiment, can have blade roots that are arranged in corresponding reception areas of the fan disc.

To avoid that the fan 10 is moved forward in the axial direction in the event of a break of the low-pressure shaft 81, an additional shaft 85 is provided, which is also connected to the fan disc 12 and represents the fan holding device insofar as it is additionally coupled to an axially rear point of the low-pressure shaft 81, so that an additional axial securing is present. However, the additional shaft 85 does not represent a securing in the case that a break of the fan disc 12 occurs, for example a break of components 121 of the fan disc 12 by means of which a connection of the fan disc 12 to the low-pressure shaft 81 is established, as shown in FIG. 2.

FIG. 2 also shows a non-rotating structural component 6 of the engine that is arranged downstream of the fan disc 12. This structural component 6 comprises a flow-path-delimiting component 65 that delimits the flow channel behind the fan 10 radially inside. In addition, it can take over structural tasks. The structural component 6 may for example be a diffuser into the core engine.

The interface 61 between the non-rotating structural component 6 and the rotating fan disc 12, which adjoins the fan hub, is characterized in that the adjoining components of the respective structural components have sufficient safety distances to reliably avoid a mechanical contact between the fan disc 12 and the non-rotating structural component 6 in the case of an axial displacement, for example due to temperature changes.

The fan securing device 10 against an axial displacement in the event of a break of the low-pressure shaft 81 or a break of the fan disc 12 according to the invention is realized by a certain embodiment of the interface 61 between the fan disc 12 and the non-rotating structural component 6 arranged downstream of the fan disc 12 (cf. FIG. 2). FIG. 3 shows such an interface 61. Otherwise, the fan and the connection of the low-pressure shaft to the fan disc can be configured according to FIG. 2, wherein no additional shaft (shaft 85 of FIG. 2) is provided according to the invention, and the axial securing of the fan is instead provided by a special embodiment of the interface 61.

According to FIG. 3, the fan disc 12 forms a downstream section 122 that extends substantially radially and from which a first web 123 extends downstream in the axial direction and a second web 124 extends at a radial distance thereto. In the axial section inside of which it extends, the second web 124 forms the radially inner boundary of the flow channel.

At its axially rear end, the first web 123 carries a plurality of first locking sections 125 that are embodied as first wall sections extending in the radial direction, and that respectively extend obliquely to the circumferential direction, as will be explained in more detail based on FIGS. 4-6. Here, the locking sections 125 are arranged at a distance from each other in the circumferential direction, wherein the distance can be equidistant. The locking sections 125 extend radially outwards, beginning at the first web 123.

Axially adjoining the second web 124, the non-rotating structural component 6 has a flow-path-delimiting component 65. At its upstream end, it forms a plurality of second locking sections 62 that are embodied as second wall sections extending in the radial direction, and that are also aligned obliquely to the circumferential direction. The individual locking sections 62 are also arranged at a distance from each other in the circumferential direction, in particular they are arranged with an equidistant distance. At that, they extend radially inwards, starting from the flow-path-delimiting component 65.

FIG. 3 shows the arrangement of the first locking sections 125 and the second locking sections 62 in normal operation. In normal operation, the first and the second locking sections 125, 62 are out of mesh with each other. At that, the first locking sections 125 have a more downstream axial position than the second locking sections 62. Thus, with respect to their axial position, the second locking sections 62 are arranged between the downstream section 122 of the fan disc 12 and the first locking sections 125. As for its radial position, they are located between the first web 123 and the second web 124, with sufficient safety distances being observed. Thus, in normal operation, what is present is a situation in which the first locking sections 125 and the second locking sections 62 are arranged at an axial distance from each other.

With respect to FIGS. 4 to 6, it is first to be understood that the first locking sections 125 as well as the second locking sections 62 are oriented obliquely to a plane that extends perpendicular to the machine axis of the turbofan engine. In the flatly spread-out rendering of FIGS. 4 to 6, this means that the locking sections 125, 62 from an angle α to the circumferential direction u (cf. FIG. 5). In the regarded cylindrical coordinate system, the circumferential direction u is indicated by the circumferential angle φ. The angle α may for example lie between 5° and 45°, in particular between 10° and 30°.

FIG. 4 illustrates how during mounting the first locking sections 125 and the second locking sections 62 are brought in the position of normal operation according to FIG. 3.

Due to the inclined position of the locking sections 62, 125, it is possible to move the first locking sections 125 through in between the second locking sections 62 in the direction of the arrow A, i.e. at an angle of the inclined position. In this manner, the first locking sections 125 can be moved past the second locking sections 62 in the axial direction, so that they have a more downstream axial position than the second locking sections 62 in the mounted state.

FIG. 5 shows the finished mounted state, when the fan is in normal operation. The locking sections 125 rotate corresponding to the arrow B in the circumferential direction, while the connection sections 62 of the non-rotating structural component 6 are stationary. Due to the axial distance between the first locking sections 125 and the second locking sections 62, these are out of mesh, and the first locking sections 125 of the fan disc can rotate freely.

As can be seen in FIG. 5, the distance d1 in the circumferential direction u between the second locking sections 62 is smaller than the length d2 in the circumferential direction of the first locking sections 125. As a result, the first locking sections 125 cannot be moved axially in front of the second locking sections 62 through a purely axial movement. A disengagement of the first and second locking sections 125, 62 can only occur if the first locking sections are guided past the second locking sections 62 in the opposite direction, as shown in FIG. 4.

However, in the event of a break of the low-pressure shaft or of the fan disc, the first locking sections 125 run further into the direction B. At that, the fan that is decoupled from the low-pressure shaft moves forwards in the axial direction. In this process, the first locking sections 125 successively come to rest against the second locking sections 62 at their downstream side, as shown in FIG. 6. In this manner, the fan is decelerated in its rotational movement and stopped in its axial movement. In this manner, the securing of the fan is provided. Here, it is provided according to one embodiment variant that the downstream side of the second locking sections 62 and the upstream side of the first locking sections 125 are respectively embodied in a smooth manner.

As shown in FIG. 5, each locking section has two end faces that, due to the oblique orientation of the locking sections, in the following will be referred to as the leading edge and the trailing edge. Thus, the first locking section 125 has a leading edge 125a [and] a trailing edge 125b. The second locking section has a leading edge 62a and a trailing edge 62b.

FIG. 7 shows the first and second locking sections 125, 62 arranged in a circular manner at a regarded point in time of their relative movement as viewed upstream in the axial direction. Drawn in are the cylindrical coordinates x, r and u. Here, FIG. 7 shows a state in which the first locking sections 125 and the second locking sections 62 are respectively arranged at a distance to each other in the circumferential direction and are embodied in such a manner that they overlap in the circumferential direction at the shown point in time upstream in the axial direction. At this point in time, a complete overlap occurs, with a first locking section 125 overlapping at its leading edge 125a with a first of the locking sections 62, and at its trailing edge 125b with a further one of the second locking sections 62. At other points in time, only a one-sided overlap is present.

FIG. 8 shows a differing embodiment in which the length of the first locking sections 125 is reduced in the circumferential direction as compared to the embodiment of FIG. 7. In FIG. 8, the degree of overlap at the shown point in time is such that, when viewed in the axial direction upstream, a first locking section 125 overlaps with one of the second locking sections 62 only at its leading edge 125a. In contrast, a gap 7 is present between its trailing edge 125b and the next second locking section 62. At other points in time, a complete overlap or a one-sided overlap is present at the trailing edge 125b.

An overlap of the locking sections 125, 62 obviously provides securing against any detachment of the fan from the engine during a purely axial movement of the fan. Due to their distance in the circumferential direction and their length, the first locking sections 125 and the second locking sections 62 ensure that the fan is secured by means of an at least one-sided overlap of the locking sections at all times.

It is to be understood that the first locking sections 125 and the second locking sections 62 are shown only schematically in FIGS. 4-8. Particularly the shown rectangular cross section is only an example. Alternatively, the locking sections can have a rounded cross section, for example at their leading and trailing edges, or can converge. The upstream and downstream surfaces can also be rounded or can converge. It is also to be understood that the middle one of the shown second locking sections is embodied to be longer than the two adjoining second locking sections in FIGS. 2-8. However, a different length of the individual second locking sections in the circumferential direction is only optional. According to one embodiment, the second locking sections all have the same length.

The present invention is not limited in its embodiment to the previously described exemplary embodiments, which are to be understood merely as examples. For example, it can alternatively be provided that the first and second locking sections are oriented in a different manner, are differently shaped, and/or have a different distance to each other in the circumferential direction.

Further, it is to be understood that the features of the individual described exemplary embodiments of the invention can be combined with each other into different combinations. As far as ranges are defined, they comprise all values within these ranges, as well as all partial ranges falling within a range.

1. A turbofan engine, comprising:
a fan that comprises a fan disc,
a low-pressure shaft that is connected to the fan disc and couples the fan to a low-pressure turbine of the turbofan engine, and
a non-rotating structural component arranged downstream of the fan disc,
characterized in that
a downstream section of the fan disc has a plurality of first locking sections that are arranged at a distance from each other in the circumferential direction,
an upstream section of the non-rotating structural component arranged downstream of the fan disc has a plurality of second locking sections that are arranged at a distance from each other in the circumferential direction,
wherein the first and the second locking sections are configured and arranged with respect to each other in such a manner that the first and the second locking sections are out of mesh with each other in normal operation, wherein the first locking sections have a more downstream axial position than the second locking sections, and
in the event of a break of the low-pressure shaft or der fan disc, when the fan disc is displaced in the axial direction upstream, the first locking sections come to rest against the second locking sections.

2. The turbofan engine according to claim 1, wherein the first locking sections and the second locking sections are respectively oriented obliquely to a plane that extends perpendicular to the machine axis of the turbofan engine.

3. The turbofan engine according to claim 1, wherein the first locking sections and the second locking sections are oriented transversely to the plane extending perpendicular to the machine axis substantially by the same angle (α).

4. The turbofan engine according to claim 1, wherein the angle (α) lies between 5° and 45°, in particular between 10° and 30°.

5. The turbofan engine according to claim 1, wherein the first locking sections and the second locking sections are embodied as first and a second wall sections respectively extending obliquely to the circumferential direction and in the radial direction.

6. The turbofan engine according to claim 1, wherein the first locking sections are formed at a first web protruding downstream of the fan disc in the axial direction, and extend radially outwards away from the same.

7. The turbofan engine according to claim 1, wherein the second locking sections extend radially inwards from a flow-path-delimiting structure of the non-rotating structural component.

8. The turbofan engine according to claim 1, wherein the first locking sections are formed at a first web protruding downstream of the fan disc in the axial direction, and extend radially inwards from the same.

9. The turbofan engine according to claim 8, wherein the second locking sections extend radially outwards from a structure of the non-rotating structural component.

10. The turbofan engine according to claim 1, wherein the fan disc forms a second web that protrudes downstream in the axial direction and that is arranged radially outside of the second locking sections.

11. The turbofan engine according to claim 1, wherein the first locking sections and the second locking sections are arranged in a ring-shaped manner.

12. The turbofan engine according to claim 1, wherein the first locking sections and the second locking sections are respectively oriented and arranged at a distance from each other in the circumferential direction in such a manner that for mounting the first locking sections can be moved through in between the second locking sections in the transverse direction (A), so that the first locking sections have a more downstream axial position than the second locking sections in normal operation.

13. The turbofan engine according to claim 1, wherein the first locking sections and the second locking sections are respectively arranged at a distance from each other in the circumferential direction in such a manner that a first locking section and a second locking section arranged at an axial distance thereto overlap at all times in the circumferential direction during operation as viewed upstream in the axial direction.

14. The turbofan engine according to claim 1, wherein the first locking sections and the second locking sections are respectively arranged equidistantly to each other in the circumferential direction.

15. The turbofan engine according to claim 1, wherein the first locking sections are formed at the axially rear end face of the fan disc.

16. The turbofan engine according to claim 1, wherein the second locking sections are formed at the axially frontal end face of the non-rotating structural component arranged downstream of the fan disc.

17. The turbofan engine according to claim 1, wherein the downstream section of the fan disc comprising the first locking sections and the upstream section of the non-rotating structural component comprising the second locking sections form an interface between the fan disc and the non-rotating structural component that is located close to the hub.

18. The turbofan engine according to claim 1, wherein the first locking sections are formed in one piece with the fan disc.

19. A turbofan engine, comprising:
a fan that comprises a fan disc,
a low-pressure shaft that is connected to the fan disc and couples the fan with a low-pressure turbine of the turbofan engine, and
a non-rotating structural component arranged downstream of the fan disc, wherein
a downstream section of the fan disc has a plurality of first locking sections that are arranged at a distance from each other in the circumferential direction, wherein the first locking sections are embodied as first wall sections that respectively extend obliquely to the circumferential direction and in the radial direction,
an upstream section of the non-rotating structural component arranged downstream of the fan disc has a plurality of second locking sections that are arranged at a distance from each other in the circumferential direction, wherein the second locking sections are embodied as second wall sections that respectively extend obliquely to the circumferential direction and in the radial direction,
and wherein the first and the second locking sections are configured and arranged with respect to each other in such a manner that the first and the second locking sections are out of mesh with each other in normal operation, wherein the first locking sections have a more downstream axial position than the second locking sections,
in the event of a break of the low-pressure shaft or of the fan disc, when the fan disc is displaced upstream in the axial direction, the first locking sections come to rest against the second locking sections.

20. A turbofan engine, comprising:
a fan that comprises a fan disc,
a low-pressure shaft that is connected to the fan disc and couples the fan with a low-pressure turbine of the turbofan engine, and
a non-rotating structural component arranged downstream of the fan disc, wherein
a downstream section of the fan disc has a plurality of first locking sections that are arranged at a distance from each other in the circumferential direction,
an upstream section of the non-rotating structural component arranged downstream of the fan disc has a plurality of second locking sections that are arranged at a distance from each other in the circumferential direction,
wherein the first and the second locking sections are configured and arranged with respect to each other in such a manner that the first and the second locking sections are out of mesh with each other in normal operation, wherein the first locking sections have a more downstream axial position than the second locking sections,
in the event of a break of the low-pressure shaft or the fan disc, when the fan disc is displaced upstream in the axial direction, the first locking sections come to rest against the second locking sections, and
the first locking sections and the second locking sections are respectively oriented obliquely to the circumferential direction and at that are arranged at a distance from each other in the circumferential direction in such a manner that, for mounting, the first locking sections can be moved though in between the second locking sections in the transverse direction (A), so that the first locking sections have a more downstream axial position than the second locking sections in normal operation.
